(19) United States
(12) Patent Application Publication
(10) Pub. No.: US 2017/0109854 A1
(43) Pub. Date: Apr. 20, 2017

(54) METHODS AND SYSTEMS FOR MANAGING ACCESS TO A DATABASE

(71) Applicants: Robert Wayne Birdsong, Deerfield Beach, FL (US); Aida G. Miller, Pompano Beach, FL (US)

(72) Inventors: Robert Wayne Birdsong, Deerfield Beach, FL (US); Aida G. Miller, Pompano Beach, FL (US)

(21) Appl. No.: 15/294,327

(22) Filed: Oct. 14, 2016

Related U.S. Application Data
(60) Provisional application No. 62/241,206, filed on Oct. 14, 2015.

(51) Int. Cl. G06Q 50/26; G06Q 50/00; G06F 17/30; G06F 21/62; G06F 21/31

(52) U.S. Cl. CPC G06Q 50/265; G06F 21/6218; G06F 21/31; G06F 17/30312; G06Q 50/01

(57) ABSTRACT

A method on a web server for managing access to an attached database comprising displaying a GUI to accept user profile, login data and user authorization data and for capturing the digital footprint of the user. The method includes transmitting the digital footprint to a first clearinghouse and determining if (a) an unwanted digital activity value associated with the footprint satisfies a predetermined threshold unwanted digital activity value; determining, by accessing a second clearinghouse, if (b) the user identity is accurate; determining, by accessing a third clearinghouse if (c) the report record value satisfies a predetermined threshold report value; and, transmitting the digital footprint to a forth clearinghouse and determining if (d) an additional unwanted activity value satisfies a predetermined threshold further unwanted digital activity value. The system only provides access to other records and profiles if a user profile satisfies conditions (a), (b), (c) and (d).

### CROSS-REFERENCE TO RELATED APPLICATIONS

This patent application claims priority to provisional patent application No. 62/241,206 filed Oct. 14, 2015. The subject matter of said is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The present invention relates to the field of managing access to databases, and more specifically to the field of accessing dating websites.

### BACKGROUND

Throughout history, people have been meeting each other, developing relationships and sometimes ultimately becoming married or lifelong partners. For almost that same period of time, people have been looking for different ways of meeting other people in order to develop relationships.

Matchmakers have been used throughout history to match people with similar interests and hobbies, who might be inclined to like one another. A matchmaker is a person who arranges relationships and marriages between others, either informally or, in certain cultural communities, as a formal occupation. In recent years, online matchmaking services have been used to match people with each other. Such online match making services or dating websites do have drawbacks. One drawback of using online dating websites is that relationships are not developed organically. One issue with not developing relationships organically is that part of the vetting process is eliminated. As a result of this elimination of the vetting process, a person may sometimes meet another person for the first time without knowing anything about the other person except for their hobbies, interests and physical appearance.

Another drawback of the existing online dating websites is that the criminal background of a person may be unknown or unverified. As a result, in some cases, a person may become involved with a person with an unacceptable criminal background. Even worse, a person may be assaulted by a person having an unacceptable criminal background.

Another drawback of the existing online websites is that users of the websites are unable to identify if a person is associated with any illicit or unfavorable habits, such as pedophilia, child abuse, or child photography.

Additionally, another drawback of exiting websites is that uses may be unable to verify if the person frequently visits websites or is associated unwanted activity such as terrorists activates or other websites that are considered un-desirable.

As a result, there exists a need for improvements over the prior art and more particularly for a more efficient and effective way to allow access to an online database for dating services or other type of type of website that requires a user to meet certain socially accepted standards.

### SUMMARY

A system and method for managing access to an attached database is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a method on a web server for managing access to an attached database is disclosed. The method includes: displaying, over the communications network, at least one GUI configured to accept user profile data and login data from a user, wherein the user profile data includes at least a user first name and user a last name; capturing a digital footprint of a user; transmitting, over the communications network, to a first clearinghouse the captured digital footprint corresponding to the user; receiving, over the communications network, the user profile data and login data; creating a user record, in the attached database, storing the user profile data and login data in the user record, wherein the attached database is configured to store a plurality of user records; displaying, over the communications network, at least a second GUI for receiving a user authorization data for conducting a background check; and receiving, over the communications network, the user authorization data for conducting the background check; storing, the user authorization data in the user record.

The method further includes: transmitting, over the communications network, the request to the first clearinghouse for an unwanted digital activity value corresponding to an amount of unwanted digital activity associated with the digital footprint, wherein the user authorization data must be at least received from the second GUI before sending the request to the first clearinghouse; receiving, over the communications network, from the first clearinghouse the unwanted digital activity value; and determining if (a) the unwanted digital activity value satisfies a predetermined threshold unwanted digital activity value.

The method also includes accessing, over the communications network, a database of a second clearinghouse having a plurality of personal identification data records, wherein each personal identification record includes at least a person's first name and person's last name, wherein the user authorization data must be at least received from the second GUI before accessing the database of the second clearinghouse; comparing the user authorization data to the plurality of personal identification records to determine the accuracy of the user profile data; and assigning an accuracy value and a record token to the user profile data; and, determining if (b) the accuracy value satisfies a predetermined threshold accuracy value, wherein if the accuracy value does not satisfy the predetermined threshold accuracy value, then denying access to the user to the attached database; or, if the accuracy value satisfies the predetermined threshold value, transmitting, over the communications network, to a third clearinghouse the record token for a second background verification phase.

The method also includes accessing, over the communications network, a database of a third clearinghouse having a plurality of report records, wherein each of the report records includes at least one record identifier and an individual identifier, wherein the individual identifiers corresponds to the record tokens; assigning a report record value based upon a computation of inappropriate record identifiers corresponding to the record identifier, which corresponds to the record token; and, determining if (c) the report record value satisfies a predetermined threshold report value.

The method also includes transmitting, over the communications network, to a fourth clearinghouse, the captured digital footprint corresponding to the user; receiving, over the communications network, from the fourth clearinghouse additional unwanted activity value; determining if (d) the child exploitation activity value satisfies a predetermined threshold additional unwanted activity value; and, providing access, over the communications network, to a user to the plurality of records in the attached database if conditions (a), (b), (c) and (d) are satisfied. Additionally, in another embodiment, the method also includes transmitting, over the communications network, a request to the fourth clearinghouse for the additional unwanted activity value, wherein the user authorization data must be at least received from the second GUI before sending the request to the fourth clearinghouse.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a diagram of an operating environment for a method on a web server for managing access to an attached database, according to an example embodiment;

FIG. 2 is a block diagram showing data flow for a method on a web server for managing access to an attached database, according to another example embodiment; and,

FIG. 3 is a process flow diagram illustrating the basic steps of a portion of registration process performed by the system, according to one example embodiment;

FIG. 4 is a process flow diagram illustrating the basic steps of a portion of the process performed by the system to determine if a proposed user has unwanted digital activity associated with his or her digital footprint, according to one example embodiment;

FIG. 5 is a process flow diagram illustrating the basic steps of a portion of the process performed by the system to determine if a proposed user's identity is accurate, according to one example embodiment;

FIG. 6 is a process flow diagram illustrating the basic steps of a portion of the process performed by the system to determine if a proposed user has any undesirable amount of inappropriate records, according to one example embodiment;

FIG. 7 is a process flow diagram illustrating the basic steps of a portion of the process performed by the system to determine if a proposed user has further unwanted digital activity associated with his or her digital footprint, and for determining if the user should have access to other users on the database, according to one example embodiment; and,

FIG. 8 is a block diagram of a system including an example computing device 800 and other computing devices.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering, or adding additional stages or components to the disclosed methods and devices. Accordingly, the following detailed description does not limit the disclosed embodiments. Instead, the proper scope of the disclosed embodiments is defined by the appended claims.

The disclosed embodiments improve over the prior art by providing a system that verifies the accuracy of the user information before conducting portions of a background check. The system also improves over the prior art by allowing the system that can greatly decrease the amount of incorrect background checks received from performing a background check in various databases. The disclosed embodiments also improve upon the problems with the prior art by providing a method and system for providing access to a database to users who have an acceptable background. The disclosed embodiments also improve over the prior art by comparing hundreds of data points to conduct a background check on a person. The disclosed embodiments also improve over the prior art by providing a bridge for several different types of databases in order to conduct a background check and decreasing the amount of time required to conduct a background check in four different databases. The disclosed embodiments improve over the prior art by providing a system for only allowing users to have access to the database who are not associated with child abuse, pedophilia, terrorism, bankruptcy, or other socially unacceptable material. The disclosed embodiments improve over the prior art by providing a safer way for users to meet people through online dating services. Disclosed embodiments also improve over the prior art by providing a safer way for users to interact with one another who has met certain standards.

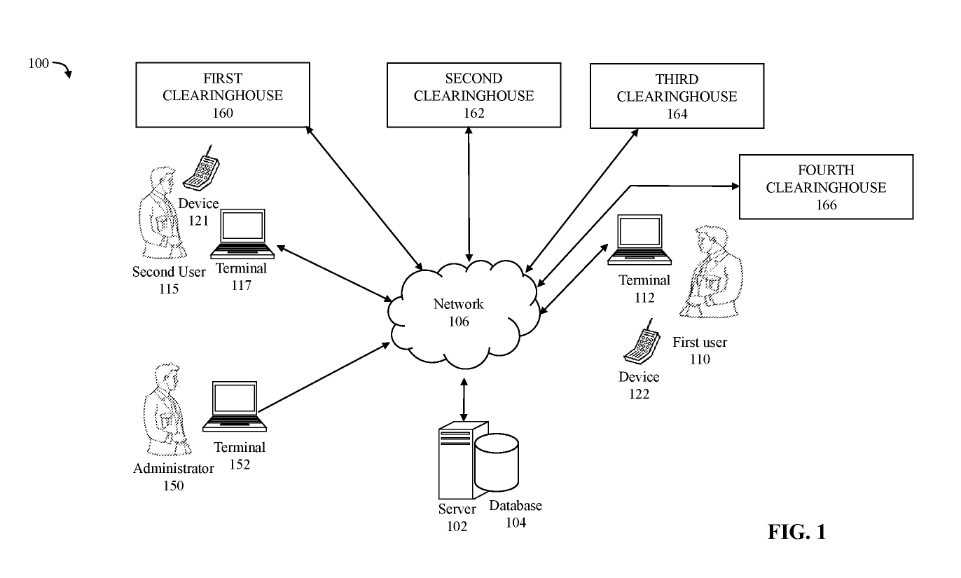

Referring now to the Figures, FIG. 1 is a schematic block diagram of an operating environment of the present invention, according to an example embodiment. FIG. 1 is a diagram of an operating environment or system 100 that supports a user profile database 104 coupled to a communications network 106, according to an example embodiment. The environment 100 may comprise mobile devices 117, 121, terminals 112, 117, 152, and clearinghouses 160, 162, 164, 166 all of which may communicate with server 102 via the communications network 106. Terminals 112, 117, 152, devices 121, 122, clearinghouses 160, 162 and 164 and servers 102 may comprise any computing device, such as integrated circuits, printed circuit boards, processors, ASICs, PCBs, cellular telephones, smart phones, tablet computers, desktop computers, laptops, and game consoles, for example.

Terminal 112 and device 122 correspond to first user 110, terminal and device 121, 117 correspond to a second user 115 and terminal 152 corresponds to Administrator 150. FIG. 1 further illustrates that server 102 includes a database or repository 104, which may be a relational database comprising a Structured Query Language (SQL) database stored in a SQL server. Devices 120, 122 and 150 may also each include their own database. The repository 104 serves data from a database, which is a repository for data used by server 102 and terminals 112, 117, 152, devices 121, 122 clearinghouses 160, 162 and 164 during the course of operation of the disclosed embodiments. Database 104 may be distributed over one or more nodes or locations that are connected via network 106.

The database may include a plurality of user records for each of the users of the system. The user record may include a user email address or other contact information, user login data 204 (user name and password), user profile data 206, user authorization 210, digital footprint 208 of a user access location, user's record token, accuracy value, report record value, unwanted activity value, additional unwanted activity value, address (street, city, state, country, county, zip code, etc.), email address, date of birth, portions of the user's social security number. Each of these elements may include elements of a programming language, a keyword, an operator, or a punctuation mark. Additionally, the user record may also include other components that are well known to those skilled in the art.

The database may include and used to store a predetermined threshold unwanted digital activity value, wherein each predetermined threshold unwanted digital activity corresponds a maximum digital activity value that can be associated with an unwanted digital activity value associated with the digital footprint of captured of a user. In one embodiment the unwanted digital activity may include digital information related to terrorist activity, pornography, or another unscrupulous digital media.

A digital footprint may include the trail, traces or “footprints” that people leave online when accessing information on the internet and may include an Internet Protocol address (IP address) of a terminal or mobile device used to access a network. An IP address is a numerical label assigned to each device (e.g., computer, printer) participating in a computer network that uses the Internet Protocol for communication. Data related to the digital footprint of a user may be transmitted, over the communications network, to a first and third clearinghouse 164. The first and third clearinghouse may receive such digital footprints and also provide data used for determining if a digital footprint of a user is associated with any unwanted digital activity or any additional unwanted activity such as terrorist activity, FBI unwanted activity, child pedophilia, sexual exploitation, human trafficking, etc.

The system can perform the method step of comparing the user authorization data 206 with the plurality of personal identification records to the plurality of personal identification records to determine the accuracy of the user authentication data, and in turn the user's identity. The system may assign an accuracy value on each piece of user data provided by the user. The system may transmit the user profile data for accuracy check 218 to the second clearinghouse where the system may compare the data associated with user first name, user last name, user address with the person's first name, person's last name, and person's address (respectively) from the plurality of personal identification records from within the database of the first clearinghouse. Based upon the comparison separate scores or accuracy value for each piece of data may (i.e. ranging from 0% accurate to 100% accurate) is provided by the system. The system may be configured such that an average of all scores of the separate pieces of data may be obtained and used to compute the accuracy value. The personal identification records from within the database of the second clearinghouse comprises hundreds of data points, which each such data point is compared with each piece of user authorization data in order to compute the accuracy value for each piece of the authorization data. Additionally, a record token 220 and may be assigned and stored in the corresponding user record based that corresponds to accuracy value.

A record token 220 or element of a programming language, a keyword, an operator, or a punctuation mark, that corresponds to the user authentication data based upon the accuracy of the user's profile. The record token may also be received from the second clearinghouse 160.

The database may include at least one predetermined threshold accuracy value. The predetermined threshold accuracy value is a value that must be satisfied in order for a user to have access to the plurality of other or second user records in the attached database 104 as will further be explained below. For example, the predetermined threshold accuracy value may be a percentage of accuracy or other scale of accuracy and may take into account, prefixes, suffixes, Scribner's errors, etc.

The database may include a plurality of report record values for each plurality of users. The report record value is based upon the computation of inappropriate record identifies corresponding to the record identifier, which corresponds to the record token of a user. In the present system, the third clearinghouse 164 includes a database having a plurality of report records. Each of the report records may include at least one record identifier and an individual identifier. The individual identifier is associated with an individual and may include the individual's first name, last name, address, date of birth, social security number, address, current location of the individual. The individual identifier may be such any one of a unique alphanumeric value, a matrix barcode, a linear barcode or a unique image, program code etc. The report record identifier may include information related to criminal court records, civil case records, administrative hearings, judgments, credit history etc. The report record may be such any one of a unique alphanumeric value, a matrix barcode, a linear barcode or a unique image, program code etc. The report identifier may also include inappropriate record identifiers and appropriate record identifiers.

The inappropriate record identifiers may be such any one of a unique alphanumeric value, a matrix barcode, a linear barcode or a unique image, program code etc. An inappropriate record identifier may include data elements that correspond to violations of a background check that are not acceptable, such as murder, assault, battery, theft, fraud, bankruptcy, hunting license suspension, etc, judgments against user.

Acceptable record identifies that are data elements that correspond to violations of a background check that are acceptable, for example, parking tickets, speeding tickets, failure to stop at a stop sign ticket, HOV lane violation, etc. etc. The acceptable record identifiers may comprise any one of a unique alphanumeric value, a matrix barcode, a linear barcode or a unique image, program code etc. trademark filings, hunting licenses, judgments for user, properties owned by user, etc.

The database may also include a predetermined threshold report value. The predetermined threshold value may be a value that the total amount of inappropriate record identifiers or total score of inappropriate record identifiers must be less than or satisfied and will be further explained below.

The database may include a predetermined threshold further unwanted digital activity value, wherein each predetermined threshold further unwanted digital activity corresponds to a maximum further digital activity value that can be associated with a further unwanted digital activity value 228 associated with the digital footprint of captured of a user. The predetermined threshold further unwanted digital activity may be defined by the administrator 150 using a GUI on terminal 125. For example, the information may be regarding values that correspond to the digital footprint of a user that is associated with child pornography, child pedophilia, human trafficking etc. The further unwanted digital activity value 228 may comprise element of a programming language, a keyword, an operator, or a punctuation mark.

Communications network 106 may one or more packet switched networks, such as the Internet, or any local area networks, wide area networks, enterprise private networks, cellular networks, phone networks, mobile communications networks, or any combination of the above. In one embodiment, mobile devices 117, 121, terminals 112, 117, 152, and clearinghouses 160, 162, 164, 166 and servers 102 is a programmable logic controller or PLC.

Server 102 includes a software engine that delivers applications, data, program code and other information to networked mobile devices 117, 121, terminals 112, 117, 152, and clearinghouses 160, 162, 164, 166. The software engine of server 102 may perform other processes such as transferring multimedia data in a stream of packets that are interpreted and rendered by a software application as the packets arrive.

FIG. 1 further shows that server 102 includes a database or repository 104, which may be a relational database comprising a Structured Query Language (SQL) database stored in a SQL server or a database that adheres to the noSQL paradigm. The database 104 may serve data, as well as related information, used by server 102 and terminals 112, 117, 152, devices 121, 122, clearinghouses 160, 162, 164 and 166 during the course of operation of the invention.

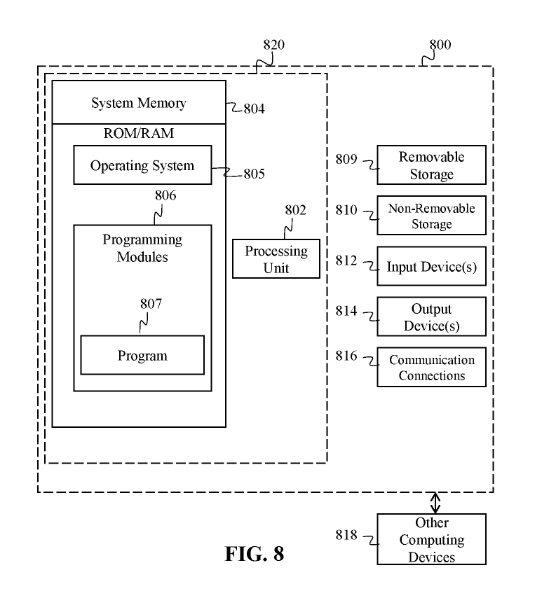

Terminals 112, 117, 152, devices 121, 122, clearinghouses 160, 162, 164 and 164 and sever 102 each include program logic comprising computer source code, scripting language code or interpreted language code that perform various functions of the present invention. In one embodiment, the aforementioned program logic may comprise program module 807 in FIG. 8. It should be noted that although FIG. 1 shows only one first user terminal 112 or device 122, only one second user terminal 117 or device 121, only one terminal 152, one first clearinghouse 160, one second clearinghouse 162 and one third clearinghouse 164, and one fourth clearinghouse 166 and one server 102, the system of the present invention supports any number of devices, servers, scanners, transmitters connected via network 106. Also note that although server 102 is shown as a single and independent entity, in one embodiment, server 102 and its functionality can be realized in a centralized fashion in one computer system or in a distributed fashion wherein different elements are spread across several interconnected computer systems.

According to one embodiment, the method provided is for managing access to an attached database 104. The system has a plurality of users, however, by way of example a first 110 and a second user 115 are shown by of example. In one embodiment, terminal 152 is configured for displaying a graphical user interface (GUI). The GUI may be for providing the interfaces for the user to input data, view data, receive messages, edit data etc.

Each of the terminals, 112, 117 and devices 122, 121 are configured for displaying GUIs provided by the system. A GUI can be configured for receiving a plurality of login 204 password data input by the first and second users. Each of the terminals are also configured for displaying other GUIs that is adapted to accept user profile data 206 and user input by the first and second users. Each of the GUIs may also be further configured for accepting hold harmless data and user authorization data 210 for conducting background checks. The user authorization data may a keystroke, depressing a button, sound, biometrics, placing a mark or any other type input that be used to accept or agree to having a background check conducted.

Each of the terminals 112, 117 and devices 122, 121 are also configured for capturing a digital footprint, which includes at least an IP address of the accessor terminal location. Each of the terminals, 112, 117 and devices 122, 121 are configured for displaying messages of denial or messages granting access to the users.

The system may also include GUIs configured to accept data associated with a manual background check or private investigation input by the administrator 150. The system and method may also be configured for displaying a message of access or denial due to a manual background check or private investigation and transmitting, over the communications network, for display on an GUI to be received by users.

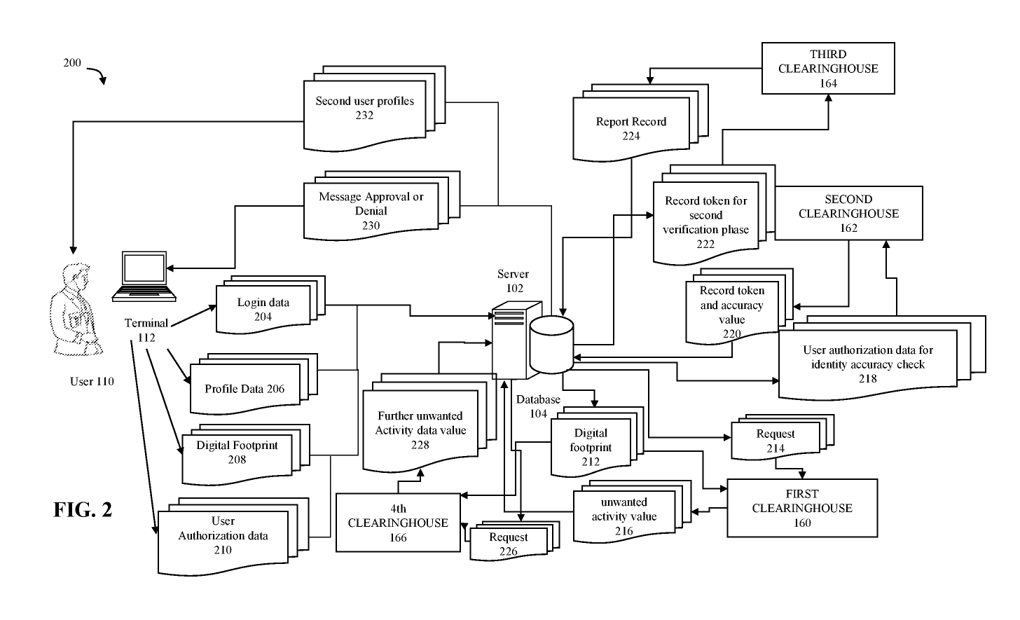

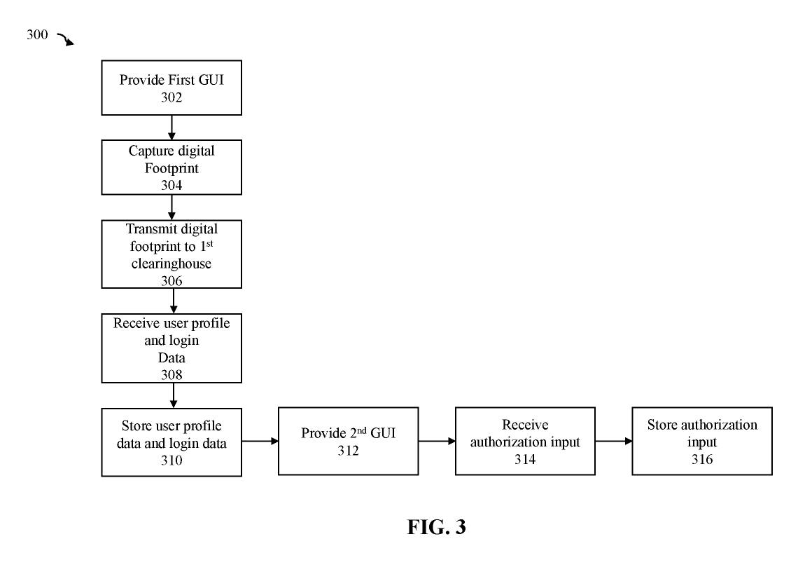

Referring to FIGS. 1, 2 and 3, the method and system for providing such method will be discussed. FIG. 1 is a diagram of an operating environment for a method on a web server for managing access to an attached database, according to an example embodiment. FIG. 2 is a block diagram showing data flow for a method on a web server for managing access to an attached database, according to another example embodiment. FIG. 3 is a process flow diagram illustrating the basic steps of a portion of registration process performed by the system, according to one example embodiment. It should be noted that FIG. 2 only includes the first user 110, however it should be understood that the method of providing access to the database described herein must be completed by each of the users having access and therefore the same method of providing access is performed for the second user 115 or any other user requesting access to the database 104. As noted above, the present invention is a method on a web server for managing access to an attached database. In one embodiment, the method is used providing access to a database for a plurality of users for a matchmaking or online dating website. However, it is understood that the systems, methods and algorithms may also be used for managing access for other types of databases such as real estate, professional associations, volunteer associations, and any other application that requires some type of background check.

The process 300 are the steps that the system completes the registration process. The system, in step 302, performs the step of displaying, over the communications network 106, at least one GUI. The GUI may be a website, webpage, or some other graphical interface adapted to be presented on a terminal 112 or mobile device 122. The GUI is also configured to accept user profile data 206 and login data 204 from a user, wherein the user profile data includes at least a user first name and user a last name, but may also include portions of the Social Security number, date of birth, age, sex, gender, address, weight, marital status, height, sexual preferences etc.

Next, the system, in step 304, once the user has access to the system via the graphical user interface, the digital footprint 208 of the device or terminal of the user is captured. A digital footprint is what is the trailer traces is left behind from a user's device. A digital footprint may include the trail, traces or “footprints” that people leave online when accessing information on the internet and may include an Internet Protocol address (IP address) of a terminal or mobile device used to access a network. An IP address is a numerical label assigned to each device (e.g., computer, printer) participating in a computer network that uses the Internet Protocol for communication.

Once the digital footprint is captured, the system as illustrated in step 306, will perform the step of transmitting the digital footprint to a first clearinghouse 160 for analyzing the digital footprint. It is understood that some of these steps may be performed both before and after or consecutively and the order is sometimes not important. The digital footprint may be captured on every webpage or GUI that the user visits while on the system. The first clearinghouse includes a database that stores the digital footprints of millions of IP addresses and other devices and the first clearinghouse searches through millions of records in order to search for the digital footprint of user.

Next, in step 308, after the user inputs the user login data 204 and user profile data 206 into the graphical user interface, the system receives the user profile data and login data. As mentioned above, the user may input the user login data 204 and user profile data 206 by simply entering the data with keystrokes or characters into various fields provided on the GUI.

Next, in step 310, the system will perform the step of creating a user record, in the attached database 104, and storing in the database the user profile data and login data in a corresponding user record. As mentioned above, attached database is configured to store a plurality of user record.

Next, in step 312, the system may provide a second GUI to the user on terminal 112. The GUI is configured for receiving authorization data 210 for granting permission for conducting a background check. Such authorization data may include user's name, signature, phone number, date of birth, the date of execution of the agreement, maiden name, current address, previous address, etc. Additionally, the authorization data may include an interface for the user to accept the terms and conditions of the hold harmless agreement.

Next, in step 314, the system will perform the step of receiving the authorization data in the corresponding user record. Next, instead 316, the system will store, the user authorization data in the corresponding user record.

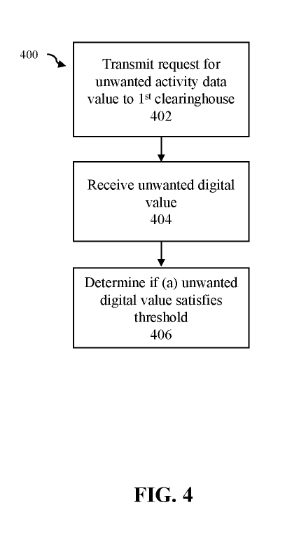

The steps of the process 400 are steps of the method the system performs to determine if the user has a digital footprint with unwanted digital activity. FIG. 4, in step 402, the system transmits, over the communications network, a request 214 to the first clearinghouse for an unwanted digital activity value 216 corresponding to an amount of unwanted digital activity associated with the digital footprint of the user. The request 214 can be a call or message that may comprise an element of a programming language, or can be a keyword, an operator, character or a punctuation mark. The user authorization data 210 may be at least received from the second GUI of the user's terminal 112 or device 122 before sending the request to the first clearinghouse. It is further understood that the first clearinghouse will not transmit the unwanted digital value until the first clearinghouse receives this request or message. This requirement ensures that the user has given permission for allowing his personal information to be subject to a background check. Having this requirement also ensures that the system owner's is held harmless from any information that may be inadvertently leaked or disclosed due to having the background check conducted.

The unwanted digital activity value 216 is a value assigned by the first clearinghouse that corresponds to the amount of unwanted digital activity that the first clearinghouse related to the digital footprints of user. As mentioned above, the system captures a digital footprint of the user every time the user moves to another graphical user interface of webpage. The unwanted digital activity value may comprise an element of a programming language, a keyword, an operator, character or a punctuation mark. The first clearinghouse includes a database that stores the digital footprints of millions of IP addresses and other devices, which have been gathered from millions of different locations. Additionally, the first clearinghouse searches through millions of records in order to search for the digital footprint of the user.

Next in step 404, the system receives, over the communications network, from the first clearinghouse the unwanted digital activity value. This value, which corresponds to a user's digital footprint may be configured to identify bot detection, proxy ID piercing, site navigation, mobile account details, tenure and status, white/black listing, past transactions, carrier analysis, device patterns and identity links. As mentioned above the unwanted digital value may include digital information corresponding to whether the digital foot print captured is associated with known IP addresses or other footprints associated with terrorist activity, pornography, or another unscrupulous digital media.

Next in step 406, the system determines if (a) the unwanted digital activity value satisfies a predetermined threshold unwanted digital activity value. The system is configured to analyze the data from the first clearinghouse and based upon hundreds of data points within the unwanted digital activity value calculate if the unwanted digital activity value meets a predetermined threshold unwanted digital activity value. As mentioned above, the predetermined threshold unwanted digital activity value corresponds to a maximum or threshold amount of digital activity value that can be associated with an unwanted digital activity value associated with the digital footprint of captured of a user. In one embodiment the unwanted digital activity may include digital information related to terrorist activity, pornography, or another unscrupulous digital media, etc. The predetermined threshold unwanted digital activity value may comprise an element of a programming language, a keyword, an operator, character or a punctuation mark. If the predetermined threshold unwanted digital activity value is not satisfied, then access to the user to the attached database may be denied. As a result of the predetermined threshold unwanted digital activity value not being satisfied and access to the database being denied, the user cannot view the other records or second user profiles 232 in the database. The user may have the ability to continue to log into the system and edit their profile. However, the user will only have access to his or her record. Additionally, the system may be configured to send a message of approval or denial 230 to the user. In one embodiments, such as a dating site or matchmaking database, if a user is denied access, the user will not have access to other user profiles 232 of the database. In certain embodiments, administrator 150 may use a GUI on terminal 152 to view the unwanted digital activity data out to make a decision if the user should be allowed to have access. The system may also allow for a delay to allow for human intelligence and analysis.

In the process 500, the system verifies the accuracy of the identify of a user. Next, in step 502, the system will access, over the communications network, a database of a second clearinghouse 162 having a plurality of personal identification data records. Each personal identification record includes at least a person's first name and person's last name. However, each personal identification record may also include user's name, signature, phone number, date of birth, a portion of the social security number, the date of execution of the agreement, maiden name, current address, previous address, hunting licenses, drivers licenses, fishing licenses, business licenses, property ownership, judgment liens, business affiliations, eviction data, telephone records, email address, tax information, vehicle information, relative information, aircraft records, professional records, records from both criminal and civil courts from numerous jurisdictions, personal filings, UCC filings, corporate information, criminal court records, civil case records, administrative hearings, judgments, credit history, SEC filings etc. The personal identification records from within the database of the first clearinghouse comprises hundreds of data points, which each such data point is compared with each piece of user authorization data in order to compute the accuracy value for each piece of the authorization data. The user authorization data must be at least received from the second GUI before accessing the database of the second clearinghouse. This requirement ensures that the user has given permission to have a background check conducted.

Next, in step 504, the system compares the authorization data input 218 by the user to the plurality of personal identification records to determine the accuracy of the data input by the user. The system compares each matching piece of data between the personal identification records and the user authorization data. In one embodiment, the system acquires separate scores on each piece of data provided in the user authorization. For example, name, address and date of birth will receive three separate scores. In one embodiment the scores may be ranging from the range 0 to 100. In addition, in one embodiment, the total score will be assigned based on the average of all scores. Based upon the comparison separate scores for each piece of data may (i.e. ranging from 0% accurate to 100% accurate) be obtained and the system, in step 506, assigns an accuracy value and record token 220. Both the token and accuracy value may comprise an element of a programming language, a keyword, an operator, character or a punctuation mark.

Next, in step 508, the system determines if the accuracy value satisfies the predetermined threshold accuracy value. As mentioned above, the predetermined threshold accuracy value is a value that must be satisfied in order for a user to have access to the plurality of other or second user records in the attached database 104. In one embodiment, for example, on a scale from 0 to 100, the predetermined threshold accuracy value may be 70. The predetermined threshold accuracy value may be a percentage of accuracy or other scale of accuracy and may take into account, prefixes, suffixes, Scribner's errors, etc. The predetermined threshold accuracy value may comprise an element of a programming language, a keyword, an operator, character or a punctuation mark. If the accuracy value of the user authorization input does not satisfy the predetermined threshold accuracy value, then the system, in step 510 may deny access to the user. If access to the attached database is denied, then, in step 512 the system may send a message to the user stating that access denied. The message may be a message on the GUI, an email, text message, etc. In one embodiment, the system may provide a GUI for the user to confirm or correct the details of the user authorization data in order to more accurately reflect information. On the other hand, if the user authorization input does satisfy the predetermined threshold accuracy value, then the system, in step 602, the system will transmit, over the communications network, to a third clearinghouse 164, the record token 220 for another phase of a background check.

The steps in process 600 are steps the system conducts for another phase of background verification. As mentioned above, the system will then transmit, over the communications network, the record token to a third clearinghouse 164.

The third clearinghouse may have a database having a plurality of report records. Each of the report records includes at least one record identifier and a corresponding an individual identifier, wherein the individual identifiers corresponds to the record tokens. The individual identifier may be associated with an individual and may include the individual's first name, last name, address, date of birth, social security number, address, current location of the individual. The individual identifier may be such any one of a unique alphanumeric value, a matrix barcode, a linear barcode or a unique image, program code etc.

The report record identifier may include information related to criminal court records, civil case records, administrative hearings, judgments, credit history etc. that is associated with the individual that corresponds to the individual identifier. The report record may comprise any one of a unique alphanumeric value, a matrix barcode, a linear barcode or a unique image, program code etc. The report identifier may also include inappropriate record identifiers and appropriate record identifiers.

The inappropriate record identifiers may be such any one of a unique alphanumeric value, a matrix barcode, a linear barcode or a unique image, program code etc. An inappropriate record identifier may include data elements that correspond to violations of a background check that are not acceptable, such as murder, assault, battery, theft, fraud etc.

Acceptable record identifies that are data elements that correspond to violations of a background check that are acceptable, for example, parking tickets, speeding tickets, failure to stop at a stop sign ticket, HOV lane violation, etc. etc. The acceptable record identifiers may be such any one of a unique alphanumeric value, a matrix barcode, a linear barcode or a unique image, program code etc. The third clearinghouse may be a vender known as TransUnion®.

The attached database 104 may also include a predetermined threshold report value. The predetermined threshold value may be a value that the total amount of inappropriate record identifiers or total score of inappropriate record identifiers must be less than or satisfied. The predetermined threshold report value may be such any one of a unique alphanumeric value, a matrix barcode, a linear barcode or a unique image, program code etc.

Next, in step 604, the system searches the third clearinghouse and assigns or generates a report record value 224 based upon the computation of the total score of inappropriate record identifiers corresponding to the record identifier. In other words, the third clearinghouse searches for records that match the record token associated with the authorization data input by the user 110. Using the record token allows for only one record to be returned. The system searches for codes associated with the inappropriate record identifiers and acceptable record identifiers associated with a record token. For example, an inappropriate record identifier may include the code <OffenseDescription1>784031AB BATTERY (DOMESTIC VIOLENCE)</OffenseDescription1>. In this case, the total amount of inappropriate record identifiers or total score of inappropriate record identifiers would not be satisfied because keywords such as “Battery”, “Domestic”, “Violence” would cause the predetermined threshold report value to not be met.

The report record value comprises a score that is generated based upon the computation performed using the third clearinghouse data that is based upon the number of acceptable record identifies and inappropriate identifiers associated with the report record associated with a record token. The report record value comprises any one of a unique alphanumeric value, a matrix barcode, a linear barcode or a unique image, program code etc. In one embodiment, the system must compare hundreds of data points from the third clearinghouse data to determine if the report record value satisfies the predetermined report value.

Next in step 608, the system determines if (c) the report record value satisfies a predetermined threshold report value. For example, if a report record associated with a record token of a user only has two or three parking tickets, or other acceptable record identifiers, then the report record value computed from the report record will have a score that satisfies the predetermined threshold report value. On the other hand, if a report record associated with a record token of the user has an inappropriate record identifier, such as murder and theft, then the total score of the inappropriate record identifier of the report record will not satisfy the predetermined threshold record value. The predetermined threshold report value can be modified depending on application.

Next, in step 610, if the report record value does not satisfy the predetermined threshold report value, then the system would deny access to the user. In one embodiment, in step 612, when the system denies user 110 access to other records in the database, then the system may send or transmit a message to the user. In other embodiments, the system may also include transmitting the digital footprint of a user to a fourth clearinghouse 166. However, in one embodiment, if a fourth clearinghouse is not used, then if conditions (a), (b) and (c) are not satisfied, then the user will only have access to said user's record if conditions (a), (b) and (c) have not been satisfied. The user may then have the opportunity to correct any errors in order to ensure that his application can be re-submitted. Additionally, the system can be configured such that the steps of determining if conditions (a), (b) and (c) are satisfied is conducted each time a user attempts to log in. And the user will have access only to said user's record if conditions (a), (b) and (c) have not been satisfied. Additionally, a message 230 will be sent notifying the user that access has been denied access to the attached database if any of conditions (a), (b) or (c) have been not satisfied each time a user attempts to log in.

The steps of the process 700 are steps of the method the system performs to determine if the user has a digital footprint 208 with further unwanted digital activity. In step 702, the system performs the step of transmitting, over the communications network, to the fourth clearinghouse 166, the captured digital footprint corresponding to the user. The fourth clearinghouse may be used to determine if the digital footprint of a user is associated with any further unwanted digital activity such as child abuse, child pedophilia or human trafficking. In one embodiment, the digital footprint is sent or transmitted to the fourth clearinghouse and the further unwanted digital value is received before the user inputs any information into the GUI. In other embodiments, the user authorization data 210 must be at least received from the second GUI before the system sends a request 226 to the fourth clearinghouse for the additional unwanted activity value. It is further understood that the fourth clearinghouse will not transmit the unwanted digital value until the fourth clearinghouse receives this request or message. This requirement ensures that the user has given permission for allowing his personal information to be subject to a background check. The request 226 can be a call or message that may comprise an element of a programming language, a keyword, an operator, character or a punctuation mark. The fourth clearinghouse includes a database that stores the digital footprints of millions of IP addresses and other devices and the fourth clearinghouse searches through millions of records in order to search for the digital footprint of user.

In step 704, the system receives, over the communications network, from the fourth clearinghouse additional unwanted activity value 228. The further unwanted digital activity value may comprise an element of a programming language, a keyword, an operator, character or a punctuation mark. This value, which corresponds to a user's digital footprint may be configured to identify bot detection, proxy ID piercing, site navigation, mobile account details, tenure and status, white/black listing, past transactions, carrier analysis, device patterns and identity links. The further unwanted digital value 228 may include digital information corresponding to whether the digital foot print captured is associated with known IP addresses or other footprints associated with unwanted material such as child abuse, child pedophilia or human trafficking.

Next in step 706, the system determines if (c) the further unwanted digital activity value satisfies a predetermined threshold further unwanted digital activity value. As mentioned above the predetermined threshold unwanted further digital activity value corresponds to a threshold or maximum value that can be associated with a further unwanted digital activity value corresponding with the digital footprint of captured of a user. In one embodiment the further unwanted digital activity may include digital information related to child abuse, child pedophilia or human trafficking. The predetermined threshold further unwanted digital activity value may comprise an element of a programming language, a keyword, an operator, character or a punctuation mark. If the predetermined threshold further unwanted digital activity value is not satisfied, then the system moves to step 711 and user 110 and will only have access to said user's records and will not have access to other records in the attached database. On the other hand, if the additional unwanted activity value satisfies the predetermined threshold additional unwanted activity value, then the system will move to step 708. In step 708 the system will determine if conditions: (a) the unwanted digital activity value satisfies a predetermined threshold unwanted digital activity value; (b) the accuracy value satisfies a predetermined threshold accuracy value; (c) the report record value satisfies a predetermined threshold report value; (d) the additional unwanted activity value satisfies a predetermined threshold additional unwanted activity value. If all conditions are met, then the system will provide providing access, over the communications network, to records in the attached database. On the other hand, if conditions (a), (b), (c) and (d) are not met then, the system would move to step 711 and the system would allow the user to have access only to said user's records and will not have access to other records or profiles 232 in the attached database. As mentioned above in one embodiment, the attached database can be a database for an online dating website. In such a case, if all conditions are not satisfied the user would not have access to the other or second user profiles 232 and would receive a message 230 stating the reasons for denial of access. If access is denied, then the system may move to step 713 and send a message denying access to the database explaining the reasons for denial.

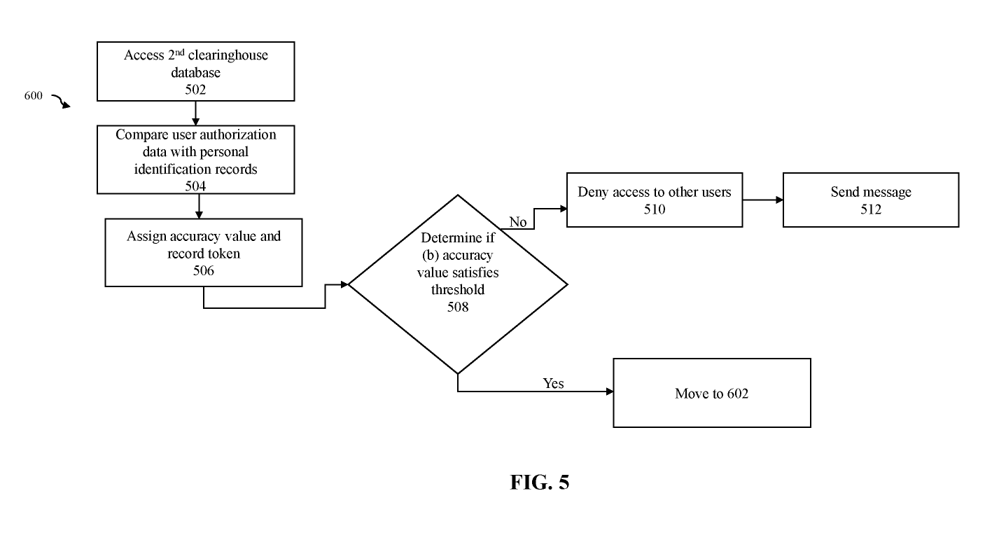

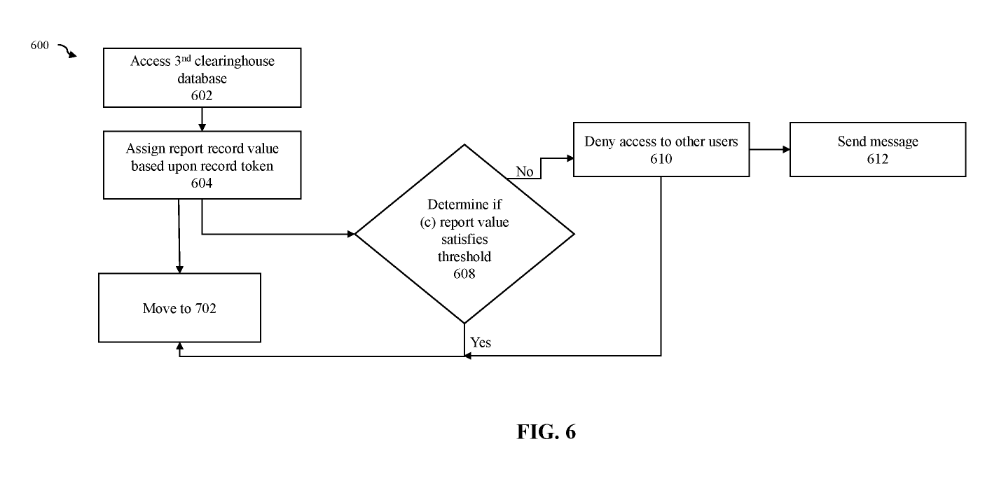

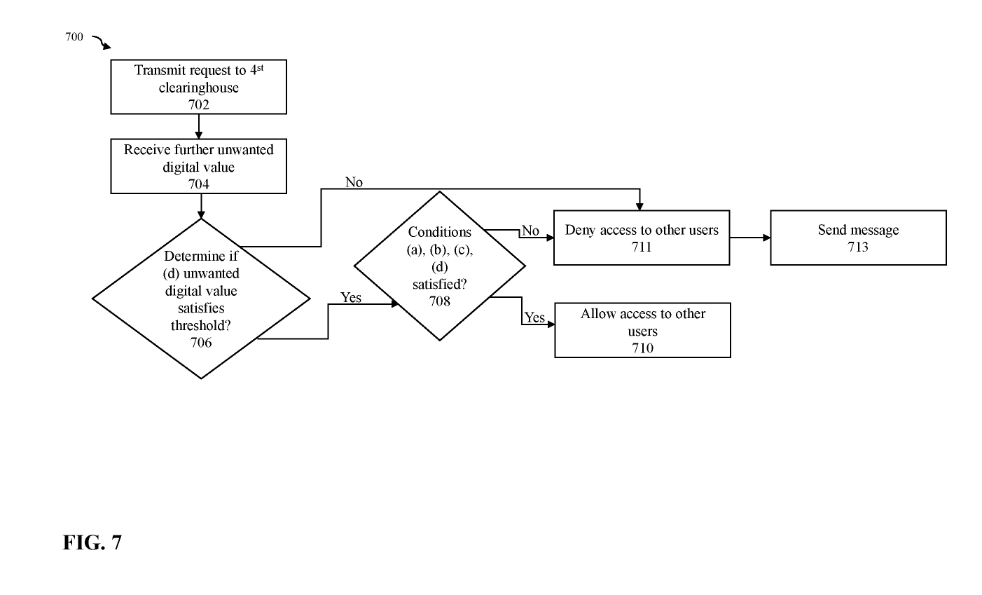

FIG. 8 is a block diagram of a system including an example computing device 300 and other computing devices. Consistent with the embodiments described herein, the aforementioned actions performed by 117, 112, 122, 121, 152, 102, 104, 160, 162, 164 and 166 may be implemented in a computing device, such as the computing device 800 of FIG. 8. Any suitable combination of hardware, software, or firmware may be used to implement the computing device 800. The aforementioned system, device, and processors are examples and other systems, devices, and processors may comprise the aforementioned computing device. Furthermore, computing device 800 may comprise an operating environment for the methods shown in FIG. 2-7 above.

With reference to FIG. 8, a system consistent with an embodiment of the invention may include a plurality of computing devices, such as computing device 800. In a basic configuration, computing device 800 may include at least one processing unit 802 and a system memory 804. Depending on the configuration and type of computing device, system memory 804 may comprise, but is not limited to, volatile (e.g. random access memory (RAM)), non-volatile (e.g. read-only memory (ROM)), flash memory, or any combination or memory. System memory 804 may include operating system 805, one or more programming modules 806 (such as program module 807). Operating system 805, for example, may be suitable for controlling computing device 800′s operation. In one embodiment, programming modules 806 may include, for example, a program module 807. Furthermore, embodiments of the invention may be practiced in conjunction with a graphics library, other operating systems, or any other application program and is not limited to any particular application or system. This basic configuration is illustrated in FIG. 8 by those components within a dashed line 820.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by a removable storage 809 and a non-removable storage 810. Computer storage media may include volatile and nonvolatile, removable and non-removable media implemented in any method or technology for storage of information, such as computer readable instructions, data structures, program modules, or other data. System memory 804, removable storage 809, and non-removable storage 810 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 800. Any such computer storage media may be part of device 800. Computing device 800 may also have data device(s) 812 such as a keyboard, a mouse, a pen, a sound input device, a camera, a touch input device, etc. Output device(s) 814 such as a display, speakers, a printer, etc. may also be included. The aforementioned devices are only examples, and other devices may be added or substituted.

Computing device 800 may also contain a communication connection 816 that may allow device 800 to communicate with other computing devices 818, such as over a network in a distributed computing environment, for example, an intranet or the Internet. Communication connection 816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 804, including operating system 805. While executing on processing unit 802, programming modules 806 may perform processes including, for example, one or more of the methods shown in FIGS. 2-7 above. The aforementioned processes are examples, and processing unit 802 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method on a web server for managing access to an attached database, the method comprising:
displaying, over the communications network, at least one GUI configured to accept user profile data and login data from a user, wherein the user profile data includes at least a user first name and user last name;
capturing a digital footprint of a user;
transmitting, over the communications network, to a first clearinghouse the captured digital footprint corresponding to the user;
receiving, over the communications network, the user profile data and login data;
creating, in the attached database, a user record and storing the user profile data and login data in the user record, wherein the attached database is configured to store a plurality of user records;
displaying, over the communications network, at least a second GUI for receiving a user authorization data for conducting a background check;
receiving, over the communications network, the user authorization data for conducting the background check;
storing, the user authorization data in the user record;
receiving, over the communications network, from the first clearinghouse an unwanted digital activity value corresponding to an amount of unwanted digital activity associated with the digital footprint;
determining if (a) the unwanted digital activity value satisfies a predetermined threshold unwanted digital activity value;
accessing, over the communications network, a database of a second clearinghouse having a plurality of personal identification data records, wherein each personal identification record includes at least a person's first name and person's last name;
comparing the user authorization data to the plurality of personal identification records to determine the accuracy of the user profile data;
assigning an accuracy value and a record token corresponding to the user authentication data;
determining if (b) the accuracy value satisfies a predetermined threshold accuracy value;
if the accuracy value does not satisfy the predetermined threshold accuracy value, then denying access to the user to the attached database; or,
if the accuracy value satisfies the predetermined threshold value, then transmitting, over the communications network, to a third clearinghouse the record token;
accessing, over the communications network, a database of a third clearinghouse having a plurality of report records, wherein each of the report records includes at least one record identifier and an individual identifier, wherein the individual identifiers corresponds to the record tokens;
assigning a report record value based upon a computation of a total score of inappropriate record identifiers corresponding to the record identifier, which corresponds to the record token;
determining if (c) the report record value satisfies a predetermined threshold report value;
providing access, over the communications network, to a user to the plurality of records in the attached database if conditions (a), (b) and (c) are satisfied.

2. The method of claim 1, wherein the user authorization data must be at least received by the second GUI before sending a request for the first clearinghouse to transit the unwanted digital activity value and accessing the databases of the second and third clearinghouses.

3. The method of claim 1, wherein the method further includes determining if conditions (a), (b) and (c) are satisfied each time the user attempts to log in, wherein the user will have access only to said user's record if conditions (a), (b) and (c) have not been satisfied.

4. The method of claim 1, wherein the method further includes sending, over a communications network, a message notifying the user that access has been denied access to the attached database if any of conditions (a), (b) or (c) have been not satisfied each time a user attempts to log in.

5. The method of claim 1, wherein the user profile data further includes at least a portion of the user social security number, a portion of the user address, date of birth, sex, marital status, height, weight, and sexual preferences.

6. The method of claim 1, wherein the personal identification record further includes at least a portion of the user social security number, a portion of the user address, date of birth, and sex.

7. The method of claim 2, wherein the method further comprises:
transmitting, over the communications network, to a fourth clearinghouse, the captured digital footprint corresponding to the user;
receiving, over the communications network, from the fourth clearinghouse a further unwanted digital activity value corresponding to an amount of further unwanted digital activity associated with the digital footprint;
determining if (d) the additional unwanted activity value satisfies a predetermined threshold further unwanted digital activity value;
providing access, over the communications network, to a user to the plurality of records in the attached database if condition (d) is also satisfied.

8. The method of claim 7, wherein the method further includes transmitting, over the communications network, a request for the fourth clearinghouse to transmit the additional unwanted activity value, wherein the user authorization data must be at least received from the second GUI before sending the request to the fourth clearinghouse.

9. The method of claim 1, wherein the method further includes determining if conditions (a), (b), (c) and (d) are satisfied each time the user attempts to log in, wherein the user will have access only to said user's record if conditions (a), (b), (c) and (d) have not been satisfied.

10. The method of claim 9, wherein the method further includes sending, over a communications network, a message notifying the user that access has been denied to the attached database if any of conditions (a), (b), (c) or (d) have not been satisfied each time a user attempts to log in.

11. A method on a web server for managing access to an attached database, the method comprising:
displaying, over the communications network, at least one GUI configured to accept user profile data and login data from a user, wherein the user profile data includes at least a user first name and user a last name;
capturing a digital footprint of a user;
transmitting, over the communications network, to a first clearinghouse the captured digital footprint corresponding to the user;
receiving, over the communications network, the user profile data and login data;
creating, in the attached database, a user record and storing the user profile data and login data in the user record, wherein the attached database is configured to store a plurality of user records;
displaying, over the communications network, at least a second GUI for receiving a user authorization data for conducting a background check;
receiving, over the communications network, the user authorization data for conducting the background check;
storing, the user authorization data in the user record;
transmitting, over the communications network, the request to the first clearinghouse for an unwanted digital activity value corresponding to an amount of unwanted digital activity associated with the digital footprint, wherein the user authorization data must be at least received from the second GUI before sending the request to the first clearinghouse;
receiving, over the communications network, from the first clearinghouse the unwanted digital activity value;
determining if (a) the unwanted digital activity value satisfies a predetermined threshold unwanted digital activity value;
accessing, over the communications network, a database of a second clearinghouse having a plurality of personal identification data records, wherein each personal identification record includes at least a person's first name and person's last name, wherein the user authorization data must be at least received from the second GUI before accessing the database of the second clearinghouse;
comparing the user authorization data to the plurality of personal identification records to determine the accuracy of the user profile data;
assigning an accuracy value and a record token corresponding to the user authentication data;
determining if (b) the accuracy value satisfies a predetermined threshold accuracy value;
if the accuracy value does not satisfy the predetermined threshold accuracy value, then denying access to the user to the attached database; or,
if the accuracy value satisfies the predetermined threshold value, then transmitting, over the communications network, to a third clearinghouse the record token;
accessing, over the communications network, a database of a third clearinghouse having a plurality of report records, wherein each of the report records includes at least one record identifier and an individual identifier, wherein the individual identifiers corresponds to the record tokens;
assigning a report record value based upon a computation of a total score of inappropriate record identifiers corresponding to the record identifier, which corresponds to the record token;
determining if (c) the report record value satisfies a predetermined threshold report value;
transmitting, over the communications network, to a fourth clearinghouse, the captured digital footprint corresponding to the user;
receiving, over the communications network, from the fourth clearinghouse additional unwanted activity value;
determining if (d) the additional unwanted activity value satisfies a predetermined threshold additional unwanted activity value;
providing access, over the communications network, to a user to the plurality of records in the attached database if conditions (a), (b), (c) and (d) are satisfied.

12. The method of claim 11, wherein the method further includes transmitting, over the communications network, a request for the fourth clearinghouse to transit the additional unwanted activity value, wherein the user authorization data must be at least received from the second GUI before sending the request to the fourth clearinghouse.

13. The method of claim 11, wherein the method further includes determining if conditions (a), (b), (c) and (d) are satisfied each time the user attempts to log in, wherein the user will have access only to said user's record if conditions (a), (b), (c) and (d) have not been satisfied.

14. The method of claim 11, wherein the method further includes sending, over a communications network, a message notifying the user that access has been denied to the attached database if any of conditions (a), (b), (c) or (d) have not been satisfied each time a user attempts to log in.

15. The method of claim 11, wherein the user profile data further includes at least a portion of the user social security number, a portion of the user address, date of birth, sex, marital status, height, weight, and sexual preferences.

16. The method of claim 11, wherein the personal identification record further includes at least a portion of the user social security number, a portion of the user address, date of birth and sex.

17. A method on a web server for managing access to an attached database, the method comprising:
displaying, over the communications network, at least one GUI configured to accept user profile data and login data from a user, wherein the user profile data includes at least a user first name and user last name;
capturing a digital footprint of a user;
transmitting, over the communications network, to a first clearinghouse the captured digital footprint corresponding to the user;
receiving, over the communications network, the user profile data and login data;
creating, in the attached database, a user record and storing the user profile data and login data in the user record, wherein the attached database is configured to store a plurality of user records;
displaying, over the communications network, at least a second GUI for receiving a user authorization data for conducting a background check;
receiving, over the communications network, the user authorization data for conducting the background check;
storing, the user authorization data in the user record;
receiving, over the communications network, from the first clearinghouse an unwanted digital activity value corresponding to an amount of unwanted digital activity associated with the digital footprint;
determining if (a) the unwanted digital activity value satisfies a predetermined threshold unwanted digital activity value;
accessing, over the communications network, a database of a second clearinghouse having a plurality of personal identification data records, wherein each personal identification record includes at least a person's first name and person's last name;
comparing the user authorization data to the plurality of personal identification records to determine the accuracy of the user profile data;
assigning an accuracy value and a record token to the user profile data;
determining if (b) the accuracy value satisfies a predetermined threshold accuracy value;
if the accuracy value does not satisfy the predetermined threshold accuracy value, then denying access to the user to the attached database; or,
if the accuracy value satisfies the predetermined threshold value, then transmitting, over the communications network, to a third clearinghouse the record token;
accessing, over the communications network, a database of a third clearinghouse having a plurality of report records, wherein each of the report records includes at least one record identifier and an individual identifier, wherein the individual identifiers corresponds to the record tokens;
assigning a report record value based upon a computation of a total score of inappropriate record identifiers corresponding to the record identifier, which corresponds to the record token;
determining if (c) the report record value satisfies a predetermined threshold report value;
providing access, over the communications network, to a user to the plurality of records in the attached database if conditions (a), (b) and (c) are satisfied, and wherein conditions (a), (b) and (c) are satisfied each time a user attempts to log in.

18. The method of claim 17, wherein the method further includes sending, over a communications network, a message notifying the user that access has been denied access to the attached database if any of conditions (a), (b) or (c) have been not satisfied each time a user attempts to log in.

19. The method of claim 17, wherein the user authorization data may include user first name, last name, signature, date of birth and a portion of the user social security number.
